(19) United States
(12) Patent Application Publication
(10) Pub. No.: US 2021/0086622 A1
(43) Pub. Date: Mar. 25, 2021

(54) APPARATUS AND METHOD FOR CONTROLLING BRAKING OF ELECTRIC AUTOMOBILE

(71) Applicant: TSINGHUA UNIVERSITY, Beijing (CN)

(72) Inventors: Junzhi ZHANG, Beijing (CN); Zhongshi ZHANG, Beijing (CN); Ruihai MA, Beijing (CN)

(21) Appl. No.: 16/499,217

(22) PCT Filed: Nov. 23, 2017
(86) PCT No.: PCT/CN2017/112531

§ 371 Date: Dec. 1, 2020

(30) Foreign Application Priority Data
Jun. 15, 2017 (CN) 201710452099.2

(51) Int. Cl. B60L 7/26; B60L 15/20

(52) U.S. Cl. CPC B60L 7/26; F16H 57/12; B60L 15/2009

(57) ABSTRACT

An apparatus and method for controlling braking of an electric automobile, which compensate for characteristics of a transmission system by means of adjusting a regenerative braking force of an electric motor and a hydraulic braking force of a hydraulic control system. The apparatus comprises an electric motor torque sensor, an electric motor rotating speed sensor, a wheel rotating speed sensor and a vehicle-mounted braking control system, wherein the vehicle-mounted braking control system comprises a half shaft torque determination module, a backlash state determination module, a backlash compensation control module, an elasticity compensation control module and a control time detection module. A backlash state is determined by means of the backlash state determination module, and according to a backlash state at a gear engagement position in a transmission system, backlash compensation control or elasticity compensation control is carried out on the transmission system by means of the backlash compensation control module or the elasticity compensation control module, so that the risk that a regenerative braking torque impact and vibration at a corresponding wheel caused by backlash and elasticity of the transmission system can be reduced. The present disclosure can be widely applied in the technical field of electric vehicles.

### TECHNICAL FIELD

The present disclosure relates to apparatus and method for controlling braking of an electric automobile, and relates to the field of electric vehicle technology.

### BACKGROUND

In an electric automobile such as a pure electric automobile, a hybrid electric automobile, and a fuel cell electric automobile, some kinetic energy of the automobile can be converted into electric energy by an electric motor regenerative braking function to improve energy economy of the entire automobile. It is also possible to dynamically adjust the electric automobile at a higher frequency using the electric motor torque control with fast and accurate characteristics to achieve the effect of improving the anti-lock braking of the vehicle. In the prior art, the transmission system is rigid by default when the regenerative braking is performed by the electric motor, and the control of the electric motor regenerative braking torque is open-loop. When the anti-lock braking is achieved by the electric motor regenerative braking torque, the target slip rate at the corresponding wheels is achieved by controlling the regenerative braking torque of the electric motor.

In fact, since the transmission system contains a resilient component such as a half shaft, the transmission system can exhibit a certain degree of elasticity when transmitting the torque, and it is also possible to introduce a backlash when the transmission system includes gear pair. Researchers have found that in the process of braking an electric automobile using an electric motor torque, the elasticity exhibited by the transmission system causes the correspondence of the amplitudes and phases of the torque to be changed before and after being transferred by the transmission system. And when the automobile is switched from driving to braking, the gear contact surface in the transmission system is reversed, and the transmission system passing through the backlash may cause an impact when the gear is re-contacted, resulting in an oscillation of the torque at the wheel. When the electric motor regenerative braking torque is dynamically adjusted at a higher frequency, especially during the anti-lock braking process carried out by using the electric motor, the negative effect of the elasticity and backlash of the transmission system may be aggravated, resulting in further deterioration of the slip rate control effect and driving comfort.

In the prior art, a transmission system characteristics compensation method is proposed for the driving process of an internal combustion engine automobile, however, this compensation method only relates to compensation for characteristics of a transmission system during the driving process of a conventional internal combustion engine automobile, no compensation being made for characteristics of a transmission system of the electric automobile, especially during the braking of the electric automobile. Since the electric motor torque response of the electric automobile is faster and may have a coupling of the regenerative braking force and the hydraulic braking force during the braking process, characteristics compensation control of the transmission system during regenerative braking of the electric motor is more complicated.

### SUMMARY

With respect to the above problems, an object of the present disclosure is to provide an apparatus and method for controlling braking of electric automobile which compensate for characteristics of a transmission system during regenerative braking of an electric automobile.

In order to achieve the above object, the present disclosure adopts the following technical solution: an apparatus for controlling braking of an electric automobile, which compensates for characteristics of a transmission system by means of adjusting a regenerative braking force of an electric motor and a hydraulic braking force of a hydraulic control system, characterized in that, it comprises an electric motor torque sensor, an electric motor rotating speed sensor, a wheel rotating speed sensor and a vehicle-mounted braking control system, wherein the vehicle-mounted braking control system comprises a half shaft torque determination module, a backlash state determination module, a backlash compensation control module, an elasticity compensation control module and a control time detecting module; the electric motor torque sensor detects a torque of the electric motor and sends it to the half shaft torque determination module; the electric motor rotating speed sensor detects a rotating speed of the electric motor and sends it to the half shaft torque determination module and the backlash state determination module, respectively; the wheel rotating speed sensor detects a wheel rotating speed of the electric automobile and sends it to the half shaft torque determination module and the backlash state determination module, respectively; the half shaft torque determination module calculates a half-shaft torque value of the transmission system based on the received torque of the electric motor, the rotating speed of the electric motor and the wheel rotating speed, and sends the half-shaft torque value to the backlash state determination module; the backlash state determination module determines a backlash state at a gear engagement position in the transmission system based on the rotating speed of the electric motor, the wheel rotating speed, and the half shaft torque value of the transmission system, wherein the backlash state includes a traversing state and an engaging state, sends the determined backlash state to the backlash compensation control module, and sends the determined backlash state and the half shaft torque value of the transmission system to the elasticity compensation control module at the same time; the backlash compensation control module adjusts the regenerative braking force of the electric motor and the hydraulic braking force of the hydraulic control system when the backlash is the traversing state based on a difference of rotating speeds of gears on both sides of the backlash in the transmission system, so as to accomplish the backlash compensation control of the transmission system; the elasticity compensation control module presets a regenerative braking torque target value of the electric motor, and adjusts the regenerative braking force of the electric motor when the backlash state is the engaging state based on the half shaft torque value of the transmission system and the preset regenerative braking torque target value of the electric motor, so as to accomplish the elasticity compensation control of the transmission system; the control time detecting module presets a control time threshold value, and sends a stop signal to the backlash compensation control module when it is detected that the control time spent for performing the backlash compensation control exceeds the preset control time threshold value, wherein the backlash compensation control module stops the backlash compensation control of the transmission system based on the stop signal.

Further, the backlash compensation control module employs a sliding mode control method, an input variable of the backlash compensation control module is a difference of the rotating speeds of gears on both sides of the backlash in the transmission system, and output variables of the backlash compensation control module are the braking torque values of the electric motor and the hydraulic control system.

Further, the elasticity compensation control module employs a PID control method, and input variables of the elasticity compensation control module are a half shaft torque value of the transmission system and a regenerative braking torque target value of the electric motor, and an output variable of the elasticity compensation control module is a torque compensation value of the electric motor.

Further, the half shaft torque determination module employs a Kalman filter.

A Method for controlling braking of an electric automobile, characterized in that, it comprises the steps of: 1) simplifying a backlash between each pair of gears in a transmission system into a single backlash rotating angle of the transmission system, and defining a range of changes in the single backlash rotating angle as 2α; defining a positive direction when an electric motor is in a driving mode and gears on both sides of the backlash in the transmission system are an engaging state, and the single backlash rotating angle being a; defining a negative direction when the electric motor is in a braking mode and the gears on both sides of the backlash in the transmission system are a traversing state, and the single backlash rotating angle being −α; when the electric motor is switched from the driving mode to the braking mode, it needs to traverse the backlash of the transmission system, the single backlash rotating angle transitions from α to −α; when the electric motor is switched from the braking mode to the driving mode, it needs to traverse the backlash of the transmission system, a single backlash rotating angle transitions from −α to α;2) in a traversing process of the electric motor from the driving mode to the braking mode, calculating a half shaft torque value of the transmission system by a half shaft torque determination module based on an electric motor torque detected by an electric motor torque sensor, an electric motor rotating speed detected by an electric motor rotating speed sensor, and a wheel rotating speed detected by a wheel rotating speed sensor; 3) determining a backlash state of the gears at both sides of the backlash in the transmission system by the backlash state determination module based on the electric motor rotating speed, the wheel rotating speed, and the half shaft torque value of the transmission system; if it is the traversing state, then proceeding to step 3); if it is the engaging state, then proceeding to step 6); 4) if the determined backlash state is a traversing state, that is, when the single backlash rotating angle of the transmission system transitions from −α to α, then adjusting a regenerative braking force of the electric motor and a hydraulic braking force of a hydraulic control system by a backlash compensation control module based on a difference of rotating speeds of the gears on both sides of the backlash in the transmission system, so as to accomplish a backlash compensation control of the transmission system; 5) if a control time detecting module detects that a control time spent for performing the backlash compensation control does not exceed a preset control time threshold, then proceeding to step 3) directly; if a control time threshold is preset by the control time detecting module and it is detected that the control time spent for performing the backlash compensation control exceeds the preset control time threshold, then sending a stop signal by the control time detecting module to the backlash compensation control module which stops the backlash compensation control of the transmission system based on the stop signal, and the determined backlash state is the engaging state, and then proceeding to step 6) to perform an elasticity compensation control of the transmission system by the elasticity compensation control module; 6) if the determined backlash state is the engaging state, that is, when the single backlash rotating angle of the transmission system transitions from α to −α, then adjusting the regenerative braking force of the electric motor directly by the elasticity compensation control module based on the half shaft torque value of the transmission system and the preset regenerative braking torque target value of the electric motor, so as to accomplish the elasticity compensation control of the transmission system.

Since employing the above technical solutions, the present disclosure has the following advantages: 1) The present disclosure is provided with a backlash state determination module, an elasticity compensation control module and a backlash compensation control module, wherein a backlash state is determined by the backlash state determination module, and a backlash compensation control or an elasticity compensation control is performed on the transmission system by means of the backlash compensation control module or the elasticity compensation control module based on a backlash state at a gear engagement position in the transmission system, so that the risk that are generative braking torque impact and vibration at a corresponding wheel caused by backlash and elasticity of the transmission system can be reduced, the accuracy of the slip rate control can be advantageously ensured and the anti-lock brake can be realized, and the braking control effect and driving comfort can be improved. 2) the present disclosure is provided with a control time detecting module which detects a control time for performing a backlash compensation control by a backlash compensation control module, so that influence of the dynamic response characteristics of the electric motor regenerative braking force due to the time spent for traversing the backlash being too long can be avoided. The present disclosure can be widely applied in the technical field of electric vehicles.

### BRIEF DESCRIPTION OF THE DRAWINGS

FIG. 1 is a schematic structural view of a drive and brake system of a conventional electric automobile;

FIG. 2 is a schematic structural view of the present disclosure;

FIG. 3 is a schematic diagram of an elasticity compensation control according to the present disclosure;

FIG. 4 is a schematic diagram of a flowchart according to the present disclosure.

### DETAILED DESCRIPTION

The present disclosure is described in detail below in conjunction with the accompanying drawings, however, it should be understood that the drawings are provided only for better understanding the disclosure and they should not be construed as any limit to the disclosure.

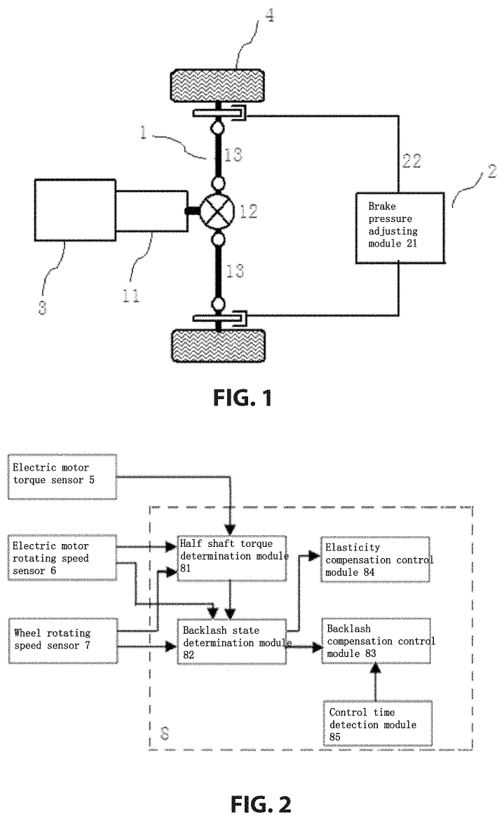

As shown in FIG. 1, a driving and braking system of an electric automobile according to the present disclosure includes a transmission system 1 and a hydraulic control system 2, wherein the transmission system 1 includes a gearbox 11, a differential 12, and two half shafts 13, and the hydraulic control system 2 includes a brake pressure adjusting module 21 and a hydraulic brake line 22. An electric motor 3 of the electric automobile is connected to one of wheels 4 of the electric automobile by a gearbox 11 and a differential 12 via two half shafts 13, respectively. The brake pressure adjusting module 21 is connected to one of the half shafts 13 by a hydraulic brake line 22, respectively, which is described in detail as a specific embodiment. However, the various components of the transmission system 1 and the hydraulic control system 2 and their connections are not limited thereto, and changes may be made depending on the specific situation accordingly.

As shown in FIG. 2, a braking control device for an electric automobile according to the present disclosure includes an electric motor torque sensor 5, an electric motor rotating speed sensor 6, a wheel rotating speed sensor 7, and a vehicle-mounted braking control system 8, wherein the vehicle-mounted braking control system 8 includes a half shaft torque determination module 81, a backlash state determination module 82, a backlash compensation control module 83, an elasticity compensation control module 84, and a control time detection module 85.

The electric motor torque sensor 5 detects a torque of the electric motor 3, and sends it to the half shaft torque determination module 81.

The electric motor rotating speed sensor 6 detects a rotating speed of the electric motor 3, and sends it to the half shaft torque determination module 81 and the backlash state determination module 82, respectively.

The wheel rotating speed sensor 7 detects a rotating speed of the wheels 4, and sends it to the half shaft torque determination module 81 and the backlash state determination module 82, respectively.

The half shaft torque determination module 81 calculates a half-shaft torque value of the half-shaft 13 (the torque finally transferred to the wheels 4 via the transmission system 1) based on the received torque of the electric motor 3, the rotating speed of the electric motor 3 and the rotating speed of the wheels 4, and send the half-shaft torque value to the backlash state determination module 82.

The backlash state determination module 82 determines a backlash state at the gear engagement position in the gearbox 11 and the differential 12 based on the received electric motor 3 rotating speed, the wheel 4 rotating speed, and the half shaft torque value of the half shaft 13, wherein the backlash state includes a traversing state and an engaging state; sends the determined backlash state to the backlash compensation control module 83; and sends the determined backlash state and the half shaft torque value of the half shaft 13 to the elasticity compensation control module 84 at the same time.

The backlash compensation control module 83 adjusts the regenerative braking force of the electric motor 3 and the hydraulic braking force of the brake pressure adjusting module 21 when the backlash is the traversing state based on a difference of the rotating speeds of the gears in the gearbox 11 and the differential 12, so as to accomplish the backlash compensation control of the transmission system 1.

The elasticity compensation control module 84 presets are generative braking torque target value of the electric motor 3, and adjusts the regenerative braking force of the electric motor 3 when the backlash state is in the engaging state based on the half shaft torque value of the half shaft 13 and the preset regenerative braking torque target value of the electric motor 3, so as to accomplish the elasticity compensation control of the transmission system 1.

The control time detecting module 85 presets a control time threshold value, and sends a stop signal to the backlash compensation control module 83 when it is detected that the control time spent for performing the backlash compensation control exceeds the preset control time threshold value. The backlash compensation control module 83 stops the backlash compensation control of the transmission system 1 based on the stop signal.

In one preferred embodiment, the backlash compensation control module 83 may employ a sliding mode control method to perform a backlash compensation control on the transmission system 1. An input variable of the backlash compensation control module 83 is a difference of rotating speeds of the gears on both sides of the backlash in the transmission system 1 (i.e., difference of the rotating speeds of the gears in the gearbox 11 and the differential 12), and output variables of the backlash compensation control module 83 are the braking torque values of the electric motor 3 and the hydraulic control system 2. And the impact is reduced by reducing the difference of the rotating speeds of the gears in the gearbox 11 and the differential 12 when the backlash is again in the engaging state, so that the electric motor 3 can complete the traversing process from the driving mode to the braking mode.

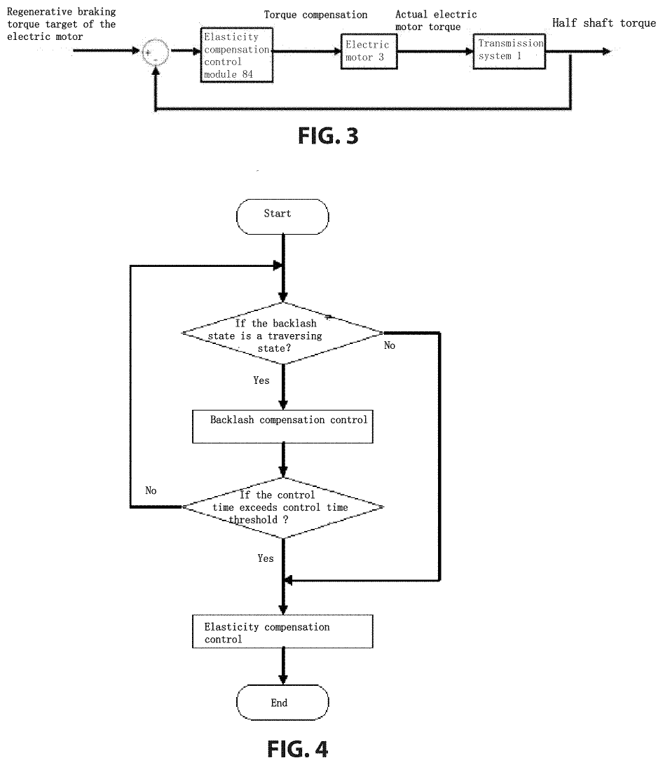

As shown in FIG. 3, the elasticity compensation control module 84 may employ a PID control method to perform elasticity compensation control on the transmission system 1. Input variables of the elasticity compensation control module 84 are a half shaft torque value of the half shaft 13 and a regenerative braking torque target value of the electric motor 3, and an output variable of the elasticity compensation control module 84 is a torque compensation value of the electric motor 3. By the elasticity compensation control module 84 outputting the torque compensation value to the electric motor 3, the electric motor 3 drives the transmission system 1 to move according to the received torque compensation value, and thereafter the half-shaft torque value of the half-shaft 13 is fed back to the elasticity compensation control module 84. The elasticity compensation control through this closed-loop manner can reduce the error between the half shaft torque value and the regenerative brake torque target value of the electric motor 3.

In one preferred embodiment, the half shaft torque determination module 81 may employ a Kalman filter.

As shown in FIG. 4, a method for controlling braking of an electric automobile according to the present disclosure will be described in detail below by means of specific embodiments:

1) The backlash between each pair of gears in the gearbox 11 and the differential 12 is simplified to a single backlash rotating angle of the transmission system 1, and a range of changes in the single backlash rotating angle is defined as 2α; a positive direction is defined when the electric motor 3 is in the driving mode and the gears on both sides of the backlash in the transmission system 1 are the engaging state, and the single backlash rotating angle is defined as α; a negative direction is defined when the electric motor 3 is in the braking mode and the gears on both sides of the backlash in the transmission system 1 are the traversing state, and the single backlash rotating angle is defined as −α; when the electric motor 3 is switched from the driving mode to the braking mode, it needs to traverse the backlash of the transmission system 1, and the single backlash rotating angle transitions from α to −α; when the electric motor 3 is switched from the braking mode to the driving mode, it needs to traverse the backlash of the transmission system 1, and the single backlash rotating angle transitions from −α to α.
2) In the traversing process of the electric motor 3 from the driving mode to the braking mode, the half shaft torque value of the transmission system 1 is calculated by the half shaft torque determination module 81 based on an electric motor 3 torque detected by the electric motor torque sensor 5, an electric motor 3 rotating speed detected by the electric motor rotating speed sensor 6, and a wheel 4 rotating speed detected by the wheel rotating speed sensor 7.
3) The backlash state of the gears at both sides of the backlash in the transmission system 1 is determined by the backlash state determination module 82 based on the rotating speed of the electric motor 3, the rotating speed of the wheels 4, and the half shaft torque value of the transmission system 1. If it is the traversing state, then proceeds to step 3); if it is the engaging state, then proceeds to step 6).
4) If the determined backlash state is a traversing state, that is, when the single backlash rotating angle of the transmission system 1 transitions from −α to α, then the regenerative braking force of the electric motor 3 and the hydraulic braking force of the hydraulic control system 2 are adjusted by the backlash compensation control module 83 based on the difference of the rotating speeds of the gears on both sides of the backlash in the transmission system 1, so as to accomplish the backlash compensation control of the transmission system 1.
5) If the control time detecting module 85 detects that the control time spent for performing the backlash compensation control does not exceed the preset control time threshold, then proceeding to step 3).

If a control time threshold is preset by the control time detecting module 85 and it is detected that the control time spent for performing the backlash compensation control exceeds the preset control time threshold, then the control time detecting module 85 sends a stop signal to the backlash compensation control module 83. The backlash compensation control module 83 stops the backlash compensation control of the transmission system 1 based on the stop signal, and then the determined backlash state is the engaging state, and then proceeding to step 6) to perform the elasticity compensation control of the transmission system 1 with the elasticity compensation control module 84.

6) If the determined backlash state is the engaging state, that is, when the single backlash rotating angle of the transmission system 1 transitions from α to −α, then the regenerative braking force of the electric motor 3 is adjusted directly by the elasticity compensation control module 84 based on the half shaft torque value of the transmission system 1 and the preset regenerative braking torque target value of the electric motor 3 so as to accomplish the elasticity compensation control of the transmission system 1.

Each of the above-mentioned embodiments is only intended to illustrate the present disclosure, in which structures, connection manner, fabrication process and the like of various components may be changed. All the equivalent modifications and improvements made on the basis of the present disclosure should not be excluded from the scope of the disclosure.

1. An apparatus for controlling braking of an electric automobile, which compensates for characteristics of a transmission system by means of adjusting a regenerative braking force of an electric motor and a hydraulic braking force of a hydraulic control system, characterized in that, the actuator comprises an electric motor torque sensor, an electric motor rotating speed sensor, a wheel rotating speed sensor and a vehicle-mounted braking control system, wherein the vehicle-mounted braking control system comprises a half shaft torque determination module, a backlash state determination module, a backlash compensation control module, an elasticity compensation control module and a control time detecting module;
the electric motor torque sensor detects a torque of the electric motor and sends it to the half shaft torque determination module;
the electric motor rotating speed sensor detects a rotating speed of the electric motor and sends it to the half shaft torque determination module and the backlash state determination module, respectively;
the wheel rotating speed sensor detects a wheel rotating speed of the electric automobile and sends it to the half shaft torque determination module and the backlash state determination module, respectively;
the half shaft torque determination module calculates a half-shaft torque value of the transmission system based on the received torque of the electric motor, the rotating speed of the electric motor and the wheel rotating speed, and sends the half-shaft torque value to the backlash state determination module;
the backlash state determination module determines a backlash state at a gear engagement position in the transmission system based on the rotating speed of the electric motor, the wheel rotating speed, and the half shaft torque value of the transmission system, wherein the backlash state includes a traversing state and an engaging state; sends the determined backlash state to the backlash compensation control module; and sends the determined backlash state and the half shaft torque value of the transmission system to the elasticity compensation control module at the same time;
the backlash compensation control module adjusts the regenerative braking force of the electric motor and the hydraulic braking force of the hydraulic control system when the backlash state is the traversing state based on a difference of rotating speeds of gears on both sides of the backlash in the transmission system, so as to accomplish the backlash compensation control of the transmission system;
the elasticity compensation control module presets a regenerative braking torque target value of the electric motor, and adjusts the regenerative braking force of the electric motor when the backlash state is the engaging state based on the half shaft torque value of the transmission system and the preset regenerative braking torque target value of the electric motor, so as to accomplish the elasticity compensation control of the transmission system; and
the control time detecting module presets a control time threshold value, and sends a stop signal to the backlash compensation control module when it is detected that the control time spent for performing the backlash compensation control exceeds the preset control time threshold value, wherein the backlash compensation control module stops the backlash compensation control of the transmission system based on the stop signal.

2. The apparatus according to claim 1, characterized in that, the backlash compensation control module employs a sliding mode control method, an input variable of the backlash compensation control module is a difference of the rotating speeds of gears on both sides of the backlash in the transmission system, and output variables of the backlash compensation control module are the braking torque values of the electric motor and the hydraulic control system.

3. The apparatus according to claim 1, characterized in that, the elasticity compensation control module employs a PID control method, and input variables of the elasticity compensation control module are a half shaft torque value of the transmission system and a regenerative braking torque target value of the electric motor, and an output variable of the elasticity compensation control module is a torque compensation value of the electric motor.

4. The apparatus according to claim 1, characterized in that, the half shaft torque determination module employs a Kalman filter.

5. A method for controlling braking of an electric automobile, characterized in that, the method comprises the steps of:
1) simplifying a backlash between each pair of gears in a transmission system into a single backlash rotating angle of the transmission system, and defining a range of changes in the single backlash rotating angle as 2α; defining a positive direction when an electric motor is in a driving mode and gears on both sides of the backlash in the transmission system are an engaging state, and the single backlash rotating angle being α; defining a negative direction when the electric motor is in a braking mode and the gears on both sides of the backlash in the transmission system are a traversing state, and the single backlash rotating angle being −α; when the electric motor is switched from the driving mode to the braking mode, it needs to traverse the backlash of the transmission system, the single backlash rotating angle transitions from α to −α; when the electric motor is switched from the braking mode to the driving mode, it needs to traverse the backlash of the transmission system, a single backlash rotating angle transitions from −α to α;
2) in a traversing process of the electric motor from the driving mode to the braking mode, calculating a half shaft torque value of the transmission system by a half shaft torque determination module based on an electric motor torque detected by an electric motor torque sensor, an electric motor rotating speed detected by an electric motor rotating speed sensor, and a wheel rotating speed detected by a wheel rotating speed sensor;
3) determining a backlash state of the gears at both sides of the backlash in the transmission system by the backlash state determination module based on the electric motor rotating speed, the wheel rotating speed, and the half shaft torque value of the transmission system; if it is the traversing state, then proceeding to step 4); if it is the engaging state, then proceeding to step 6).
4) if the determined backlash state is a traversing state, that is, when the single backlash rotating angle of the transmission system transitions from −α to α, then adjusting a regenerative braking force of the electric motor and a hydraulic braking force of a hydraulic control system by a backlash compensation control module based on a difference of rotating speeds of the gears on both sides of the backlash in the transmission system, so as to accomplish a backlash compensation control of the transmission system;
5) if a control time detecting module detects that a control time spent for performing the backlash compensation control does not exceed a preset control time threshold, then proceeding to step 3);
if a control time threshold is preset by the control time detecting module and it is detected that the control time spent for performing the backlash compensation control exceeds the preset control time threshold, then sending a stop signal by the control time detecting module to the backlash compensation control module which stops the backlash compensation control of the transmission system based on the stop signal, and the determined backlash state is the engaging state, and then proceeding to step 6) to perform an elasticity compensation control of the transmission system by the elasticity compensation control module;
6) if the determined backlash state is the engaging state, that is, when the single backlash rotating angle of the transmission system transitions from α to −α, then adjusting the regenerative braking force of the electric motor directly by the elasticity compensation control module based on the half shaft torque value of the transmission system and the preset regenerative braking torque target value of the electric motor, so as to accomplish the elasticity compensation control of the transmission system.

6. The apparatus according to claim 2, characterized in that, the half shaft torque determination module employs a Kalman filter.

7. The apparatus according to claim 3, characterized in that, the half shaft torque determination module employs a Kalman filter.
